(19) United States
(12) Patent Application Publication
(10) Pub. No.: US 2025/0383594 A1
(43) Pub. Date: Dec. 18, 2025

(54) ILLUMINATION SYSTEM AND PROJECTION APPARATUS

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 19/209,767

(22) Filed: May 15, 2025

(30) Foreign Application Priority Data
Jun. 17, 2024 (CN) 202410773785.X

(51) Int. Cl. G03B 21/20; H04N 9/31

(52) U.S. Cl. CPC G03B 21/204; G03B 21/206; G03B 21/2066; G03B 21/208; H04N 9/3197

(57) ABSTRACT

Disclosed is a projection apparatus and an illumination system. The illumination system is configured provide an illumination light beam. The illumination system includes a light source module, a wavelength conversion element, and a light guide module. The light source module includes a first laser light source, a second laser light source, and a third laser light source, respectively configured to emit a first laser light beam, a second laser light beam, and a third laser light beam. The wavelength conversion element is configured to convert the first laser light beam to a conversion light beam in sequence. The light guide module includes a first full-spectrum light splitting element and a reflection element. The second laser light beam and the third laser light beam are incident on a first side of the first full-spectrum light splitting element, and the conversion light beam is incident on a second side thereof.

### CROSS-REFERENCE TO RELATED APPLICATION

This application claims the priority benefit of China application serial no. 202410773785.X, filed on Jun. 17, 2024. The entirety of the above-mentioned patent application is hereby incorporated by reference herein and made a part of this specification.

### BACKGROUND

### Technical Field

The disclosure relates to an optical system and an optical apparatus, and in particular to an illumination system and a projection apparatus.

### Description of Related Art

With the advancement of projection technology, a projection apparatus that may provide a projection image with high brightness has been developed. Compared a former projection apparatus that provides a projection image with lower brightness and needs to be used in a very dark environment, the projection apparatus that may provide the projection image with high brightness may be used in a relatively higher ambient brightness.

A light path of a laser light beam generated by a three-color pure laser and a light path of a conversion light beam (such as fluorescence) generated by excitation of a wavelength conversion element (including phosphor) by the laser may merge through a dichroic film. However, since a wavelength of a green laser light partially overlaps with a wavelength of a green fluorescent light, in order to allow the green laser light to pass through the dichroic film and merge with a light path of the green fluorescent light, part of the brightness of a fluorescence band may be sacrificed, resulting in a problem of reduced light efficiency and a deterioration in the quality of the projection image.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system that may effectively improve light utilization efficiency.

The disclosure provides a projection apparatus that may effectively improve light utilization efficiency.

Other objectives and advantages of the disclosure may be further understood from the technical features disclosed herein.

To achieve one or a part or all of the above or other objectives, an illumination system according to an embodiment of the disclosure is configured to provide an illumination light beam. The illumination system includes a light source module, a wavelength conversion element, a light guide module, and a light converging element. The light source module includes a first laser light source, a second laser light source, and a third laser light source, respectively configured to emit a first laser light beam, a second laser light beam, and a third laser light beam of different wavelengths. The wavelength conversion element disposed on a transmission path of the first laser light beam is configured to convert the first laser light beam into a conversion light beam in sequence. The light guide module includes a first full-spectrum light splitting element and a reflection element. The first full-spectrum light splitting element is disposed on transmission paths of the second laser light beam and the third laser light beam from the light source module, and the first laser light beam and the conversion light beam from the wavelength conversion element. The second laser light beam and the third laser light beam are incident on a first side of the first full-spectrum light splitting element. The conversion light beam is incident on a second side of the first full-spectrum light splitting element. The first full-spectrum light splitting element is configured to guide a first part of the illumination light beam to a first area of the light converging element, and is configured to guide a second part of the illumination light beam to the reflection element. The reflection element is configured to reflect the second part of the illumination light beam to a second area of the light converging element. The illumination light beam includes at least one of the first laser light beam, the second laser light beam, the third laser light beam, and the conversion light beam.

To achieve one or a part or all of the above or other objectives, a projection apparatus according to an embodiment of the disclosure includes the illumination system, a light valve, and a projection lens. The light valve disposed on a transmission path of the illumination light beam is configured to convert the illumination light beam into an image light beam. The projection lens disposed on a transmission path of the image light beam is configured to project the image light beam out of the projection apparatus.

In the illumination system and the projection apparatus according to the embodiment of the disclosure, the first full-spectrum light splitting element and the reflection element are used. The first full-spectrum light splitting element is configured to guide the first part of the illumination light beam to the first area of the light converging element, and is configured to guide the second part of the illumination light beam to the reflection element. The reflection element is configured to reflect the second part of the illumination light beam to the second area of the light converging element. In this way, when the laser light beam and the conversion light beam are transmitted to the light converging element, sacrificing part of the light spectrum due to the use of a dichroic mirror disposed on a light path of the first part and the second part of the illumination light beam may be avoided. Therefore, the illumination system and the projection apparatus according to the embodiment of the disclosure may effectively improve light utilization efficiency to allow the projection apparatus to provide a projection image with higher brightness.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a light path of a projection apparatus according to an embodiment of the disclosure.

FIG. 2A is a front schematic diagram of the wavelength conversion element in FIG. 1.

FIG. 2B is a timing diagram of the first laser light source, the second laser light source and the third laser light source in FIG. 1, and a first region, a second region, a third region and a fourth region of a wavelength conversion element.

FIG. 3A is a schematic diagram of a light path of an illumination system according to another embodiment of the disclosure.

FIG. 3B and FIG. 3C are schematic diagrams of a light path of an illumination system according to another two embodiments of the disclosure.

FIG. 4 is a schematic diagram of a light path of an illumination system according to another embodiment of the disclosure.

FIG. 5 is a schematic diagram of a light path of an illumination system according to another embodiment of the disclosure.

FIG. 6 is a schematic diagram of a light path of a projection apparatus according to another embodiment of the disclosure.

FIG. 7A is a front schematic diagram of another embodiment of the wavelength conversion element in FIG. 1.

FIG. 7B is a timing diagram of the first laser light source, the second laser light source and the third laser light source in FIG. 1, and the first region and the second region of the wavelength conversion element of FIG. 7A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

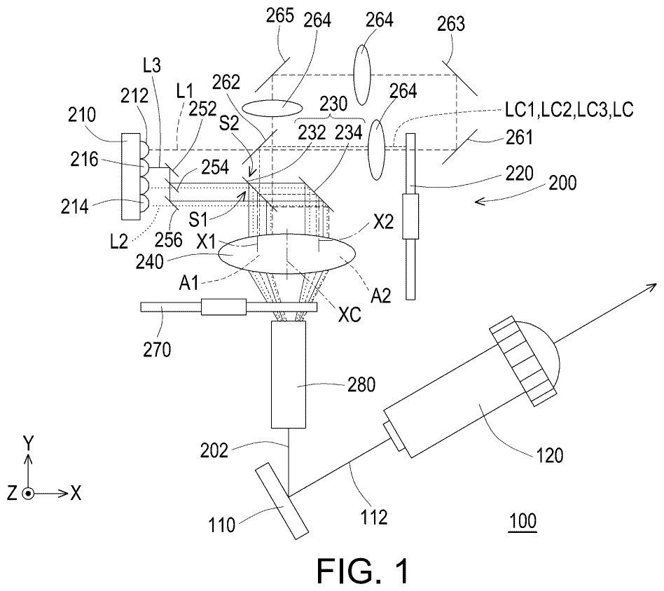

FIG. 1 is a schematic diagram of a light path of a projection apparatus according to an embodiment of the disclosure. Please refer to FIG. 1. A projection apparatus 100 of the embodiment includes an illumination system 200, a light valve 110, and a projection lens 120. The projection apparatus 100 is, for example, a projector. The illumination system 200 is configured to provide an illumination light beam 202. The illumination system 200 includes a light source module 210, a wavelength conversion element 220, a light guide module 230, and a light converging element 240. The light source module 210 includes a first laser light source 212, a second laser light source 214, and a third laser light source 216, respectively configured to emit the first laser light beam L1, the second laser light beam L2, and the third laser light beam L3 of different wavelengths. In the embodiment, the first laser light source 212, the second laser light source 214, and the third laser light source 216 are laser diodes that, for example, may respectively be one or multiple blue laser diodes, one or multiple red laser diodes, and one or multiple green laser diodes. The first laser light beam L1, the second laser light beam L2, and the third laser light beam L3 are, for example, respectively a blue light beam, a red light beam, and a green light beam.

The wavelength conversion element 220 disposed on a transmission path of the first laser light beam L1 is configured to convert the first laser light beam L1 into a conversion light beam LC in sequence. The light guide module 230 includes a first full-spectrum light splitting element 232 and a reflection element 234. The first full-spectrum light splitting element 232 is disposed on transmission paths of the second laser light beam L2 and the third laser light beam L3 from the light source module 210, and the first laser light beam L1 and the conversion light beam LC from the wavelength conversion element 220. The second laser light beam L2 and the third laser light beam L3 are incident on a first side S1 of the first full-spectrum light splitting element 232. The conversion light beam LC is incident on a second side S2 of the first full-spectrum light splitting element 232. The light splitting element 232 is arranged at an angle (e.g., 45 degrees) with respect to a central axis XC of the converging element 240. The first side S1 and the second side S2 are opposite sides of the first full-spectrum light splitting element 232. In this embodiment, the first side S1 faces the light source module 210, and the second side S2 faces the wavelength conversion element 220.

The first full-spectrum light splitting element 232 is adapted to divide the illumination light beam 202 into a first part and a second part. The first full-spectrum light splitting element 232 is configured to guide the first part of the illumination light beam 202 to a first area A1 of the light converging element 240, and is configured to guide the second part of the illumination light beam 202 to the reflection element 234. The reflection element 234 is configured to reflect the second part of the illumination light beam 202 to a second area A2 of the light converging element 240. The first part and the second part of the illumination light beam 202 from the first full-spectrum light splitting element 232 and the reflection element 234 are incident on the light converging element 240 along a direction parallel to the central axis XC. In the embodiment, the first full-spectrum light splitting element 232 and the reflection element 234 are disposed in parallel. The illumination light beam 202 includes at least one of the first laser light beam L1, the second laser light beam L2, the third laser light beam L3, and the conversion light beam LC. The term “full-spectrum light splitting element” refers to the light splitting element (the first full-spectrum light splitting element 232) has no wavelength selectivity, and simply divides light beams with all wavelengths into a pass-through part and a reflection part according to a certain proportion, and may be, for example, a beam splitter or a non-wavelength-selective optical film. The reflection element 234 is, for example, a reflective mirror. On a reference plane (parallel to a Y-Z plane) that passes through the central axis XC of the light converging element 240 and is perpendicular to the figure plane (parallel to an X-Y plane) of FIG. 1, the light converging element 240 is divided into the first area A1 located on a left side of the reference plane and the second area A2 located on a right side of the reference plane. The X-Y plane is formed by an X-axis and a Y-axis, and the Y-Z plane is formed by the Y-axis and a Z-axis. The X-axis, the Y-axis, and the Z-axis are perpendicular to each other.

The light valve 110 is disposed on a transmission path of the illumination light beam 202 and configured to convert the illumination light beam 202 into an image light beam 112. In the embodiment, the light valve 110 is, for example, a digital micro-mirror device (DMD) or a liquid-crystal-on-silicon (LCOS) panel. In other embodiments, the light valve 110 may also be a transmissive liquid crystal display (LCD) panel or other types of spatial light modulator (SLM). In the embodiment, the projection lens 120 is disposed on a transmission path of the image light beam 112 and configured to project the image light beam 112 out of the projection apparatus 100, and may project on a screen or a wall to form a projection image.

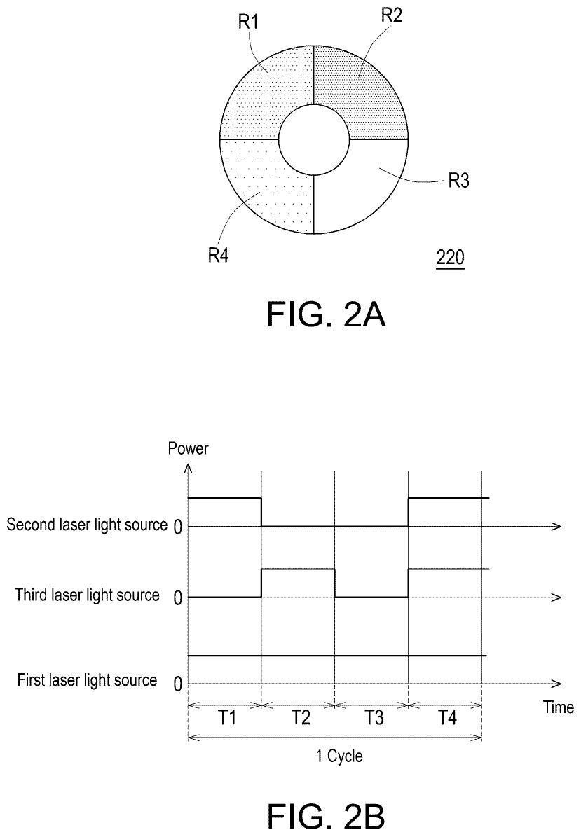

FIG. 2A is a front schematic diagram of the wavelength conversion element in FIG. 1, and FIG. 2B is a timing diagram of the first laser light source, the second laser light source and the third laser light source in FIG. 1, and a first region, a second region, a third region and a fourth region of a wavelength conversion element. Please refer to FIG. 1, FIG. 2A, and FIG. 2B. In the embodiment, the conversion light beam LC includes at least one of a first conversion light beam LC1, a second conversion light beam LC2, and a third conversion light beam LC3. One cycle includes a first timing T1, a second timing T2, a third timing T3, and a fourth timing T4. During the first timing T1, the first laser light source 212 and the second laser light source 214 are turned on (the third laser light source 216 is turned off), and the first laser light beam L1 is converted into the first conversion light beam LC1 by the wavelength conversion element 220. During the second timing T2, the first laser light source 212 and the third laser light source 216 are turned on (the second laser light source 214 is turned off), and the first laser light source 212 is converted into the second conversion light beam LC2 by the wavelength conversion element 220. During the third timing T3, the first laser light source 212 is turned on (the second laser light source 214 and the third laser light source 216 are turned off), and the first laser light beam L1 passes through the wavelength conversion element 220 or is reflected by the wavelength conversion element (for example, passing through the wavelength conversion element 220 in FIG. 1). During the fourth timing T4, the first laser light source 212, the second laser light source 214, and the third laser light source 216 are turned on, and the third laser light beam L2 is converted into the third conversion light beam LC3 by the wavelength conversion element 220.

In the embodiment, the wavelength conversion element 220 includes a first region R1, a second region R2, a third region R3, and a fourth region R4 that are located on the transmission path of the first laser light beam L1 respectively during the first timing T1, the second timing T2, the third timing T3, and the fourth timing T4. The first region R1, the second region R2, and the fourth region R4 are, for example, wavelength conversion regions, and the third region R3 is, for example, a non-wavelength conversion region. A wavelength range of the conversion light beam LC covers at least a wavelength range of one of the third laser light beam L3 (that is, a green laser light beam) and the second laser light beam L2 (that is, a red laser light beam). In the embodiment, the first region R1 is, for example, a red phosphor region, the second region R2 is, for example, a green phosphor region, the third region R3 is, for example, a pass-through region or a reflection region, and the fourth region R4 is, for example, a yellow phosphor region. In the embodiment, the wavelength conversion element 220 is, for example, a phosphor wheel.

During the first timing T1, the first region R1 converts the first laser light beam L1 into the first conversion light beam L1 (for example, a red light beam). During the second timing T2, the second region R2 converts the first laser light beam L1 into the second conversion light beam L2 (for example, a green light beam). During the third timing T3, the third region R3 allows the first laser light beam L1 to pass through, or reflects the first laser light beam L1. During the fourth timing T4, the fourth region R4 converts the first laser light beam L1 into the third conversion light beam L3 (for example, a yellow light beam).

In the embodiment, a transmittance of the first full-spectrum light splitting element 232 falls within a range of 40% to 60%, and a reflectivity thereof falls within a range of 40% to 60%. In the embodiment, the first laser light source 212, the second laser light source 214, and the third laser light source 216 are formed as a single packaged module. Multiple blue laser diodes, multiple red laser diodes, and multiple green laser diodes are arranged in an array. The first laser light beam L1 from the wavelength conversion element 220 is incident on the second side S2 of the first full-spectrum light splitting element 232. In the embodiment, the second laser light beam L2 (the red light beam) and the third laser light beam L3 (the green light beam) are incident on the first side S1 of the first full-spectrum light splitting element 232, and the first laser light beam L1 (the blue light beam) and the conversion light beam LC from the wavelength conversion element 220 are incident on the second side S2 of the first full-spectrum light splitting element 232. A main optical axis X1 of the first part of the illumination light beam 202 incident on the first area A1 of the light converging element 240 and a main optical axis X2 of the second part of the illumination light beam 202 incident on the second area A2 of the light converging element 240 are symmetrical with respect to the central axis XC of the light converging element 240. In the embodiment, the light converging element 240 is, for example, a condenser lens.

In the embodiment, the illumination system 200 further includes a reflector 252, a beam splitter 254, and a dichroic mirror 256. The reflector 252 is configured to reflect the third laser light beam L3 emitted from the third laser light source 216 to the beam splitter 254. The beam splitter 254 is configured to reflect a part of the third laser light beam L3 from the reflector 252, and is configured to allow another part of the third laser light beam L3 from the reflector 252 to pass through. The beam splitter 254 is configured to allow the second laser light beam L2 emitted from the second laser light source 214 to pass through. The dichroic mirror 256 is configured to reflect the third laser light beam L3 from the beam splitter 254, and is configured to allow another second laser light beam L2 emitted from another second laser light source 214 to pass through. In the embodiment, a light source array of the light source module 210 is an array including one (or one row) blue light source(s) corresponding to the first laser light source 212, one (or one row) green light source(s) corresponding to the third laser light source 216, two (or two rows) red light sources corresponding to the second laser light source 214 and the other second laser light source 214. In the embodiment, the dichroic mirror 256 is, for example, a dichroic mirror that reflects green light.

The second laser light beam L2 and the third laser light beam L3 from the beam splitter 254 and the dichroic mirror 256 are incident on the first side S1 of the first full-spectrum light splitting element 232. The first full-spectrum light splitting element 232 is configured to reflect a part of the second laser light beam L2 and the third laser light beam L3 from the beam splitter 254 and the dichroic mirror 256 to the first area A1 of the light converging element 240, and to allow another part of the second laser light beam L2 and the third laser light beam L3 from the beam splitter 254 and the dichroic mirror 256 to pass through and be transmitted to the reflection element 234, and the another part of the second laser light beam L2 and the third laser light beam L3 is reflected by the reflection element 234 to the second area A2 of the light converging element 240.

On the other hand, the first laser light beam L1 emitted from the first laser light source 212 passes through a dichroic mirror 262 and is transmitted to the wavelength conversion element 220. During the third timing T3, the first laser light beam L1 passes through the third region R3 of the wavelength conversion element 220 and is reflected by reflectors 261, 263, and 265 back to the dichroic mirror 262 in sequence, and passes through the dichroic mirror 262 and is transmitted to the second side S2 of the first full-spectrum light splitting element 232. During the first timing T1, the second timing T2, and the fourth timing T4, the wavelength conversion element 220 converts the first laser light beam L1 into the conversion light beam LC, and then the conversion light beam LC is reflected by the dichroic mirror 262 to the second side S2 of the first full-spectrum light splitting element 232.

The first full-spectrum light splitting element 232 is configured to allow part of the first laser light beam L1 and the conversion light beam LC from the dichroic mirror 262 to pass through the first full-spectrum light splitting element 232 and be transmitted to the first area A1 of the light converging element 240. The first full-spectrum light splitting element 232 is configured to reflect another part of the first laser light beam L1 and the conversion light beam LC from the dichroic mirror 262 to the reflection element 234, and another part of the first laser light beam L1 and the conversion light beam LC is reflected by the reflection element 234 to the second area A2 of the light converging element 240. In the embodiment, the dichroic mirror 262 is, for example, a dichroic mirror that reflects red light, green light, and yellow light.

In the embodiment, the illumination system 200 may further include multiple lenses 264 that are respectively disposed in light paths between the dichroic mirror 262 and the reflector 261, between the reflector 263 and the reflector 265, and between the reflector 265 and the dichroic mirror 262, so that the light beam is kept collimated.

In the embodiment, the illumination system 200 further includes a light homogenizing element 280 that is disposed on the transmission paths of the first laser light beam L1, the second laser light beam L2, the third laser light beam L3, and the conversion light beam LC from the light converging element 240. The light homogenizing element 280 is configured to adjust a shape of a light spot of the light beam, so that the shape of the light spot of the illumination light beam 202 output from the light homogenizing element 280 matches a shape of a working area of the light valve 110 (for example, rectangular), and to ensure that various parts of the light spot to have a consistent or similar light intensity, thereby homogenizing a light intensity of the illumination light beam 202. In the embodiment, the light homogenizing element 280 is, for example, a light integration rod. In other embodiments, the light homogenizing element 280 may also be a lens array or a diffuser. The central axis XC of the light converging element 240 is aligned with a center of the light homogenizing element 280.

In the embodiment, the illumination system 200 further includes a filter element 270 located between the light converging element 240 and the light homogenizing element 280. In the embodiment, the filter element 270 is, for example, a color filtering wheel. The filter color wheel has multiple filtering regions of different colors, and the filter color wheel may be rotated to allow the filtering regions to be sequentially located in the transmission path of the illumination light beam 202. For example, in an embodiment, the filter color wheel may have a red filtering region, a green filtering region, a colorless diffusion region, and a yellow filtering region that are respectively corresponding to the first region R1, the second region R2, the third region R3, and the fourth region R4 of the wavelength conversion element 220 in sequence. The illumination light beam 202 from the light converging element 240 is filtered through the filter element 270 to obtain a higher color purity, and then is incident on the light homogenizing element 280.

In the illumination system 200 and the projection apparatus 100 of the embodiment, the first full-spectrum light splitting element 232 and the reflection element 234 are used. The first full-spectrum light splitting element 232 is configured to guide the first part of the illumination light beam 202 to the first area A1 of the light converging element 240, and is configured to guide the second part of the illumination light beam 202 to the reflection element 234. The reflection element 234 is configured to reflect the second part of the illumination light beam 202 to the second area A2 of the light converging element 240. In this way, when a laser light beam (such as the first laser light beam L1, the second laser light beam L2, and the third laser light beam L3) and the conversion light beam LC are transmitted to the light converging element 240, spectral loss caused by the use of dichroic mirror on the light path of the first part and the second part of the illumination light beam 202 may be avoided. Therefore, the illumination system 200 and the projection apparatus 100 of the embodiment can effectively improve the light utilization efficiency and allow the projection apparatus 100 to provide a projection image with higher brightness.

In the illumination system 200 and the projection apparatus 100 of the embodiment, the laser light beam (such as the second laser light beam L2 or the third laser light beam L3) and the conversion light beam LC that have overlapping wavelength ranges may be combined during the same timing, thereby achieving high light combining efficiency. In the illumination system 200 and the projection apparatus 100 of the embodiment, a speckle phenomenon may be decreased by the light source module 210 being in conjunction with the wavelength conversion element 220, and the first full-spectrum light splitting element 232 and the reflection element 234 are used to merge the light paths to effectively shrink the size of the illumination system 200 and the projection apparatus 100.

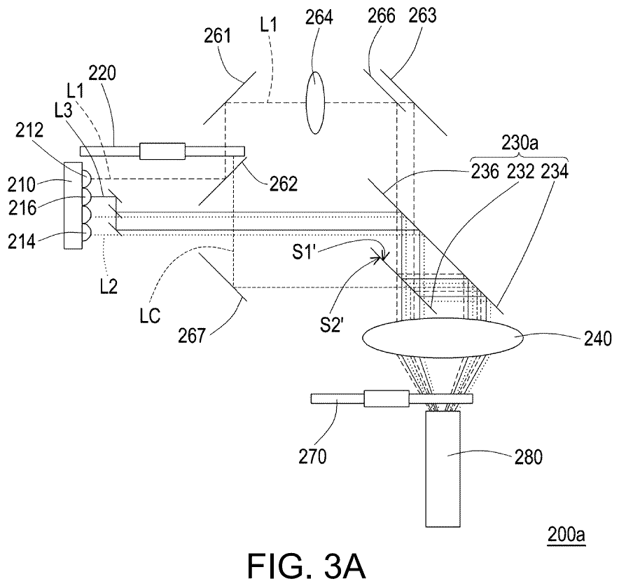

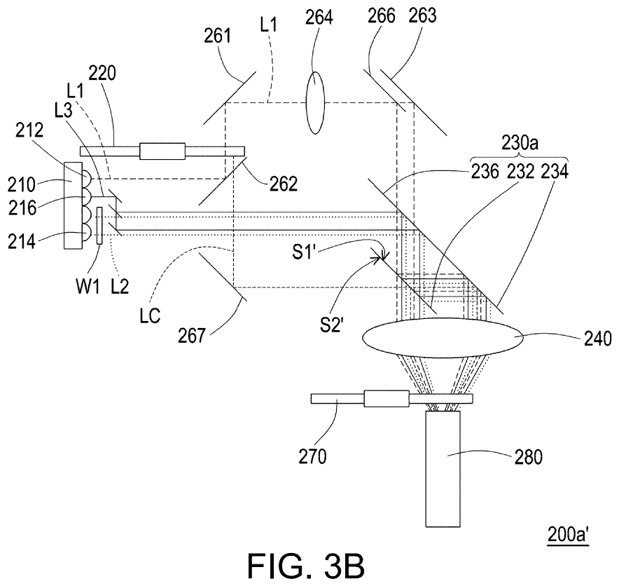

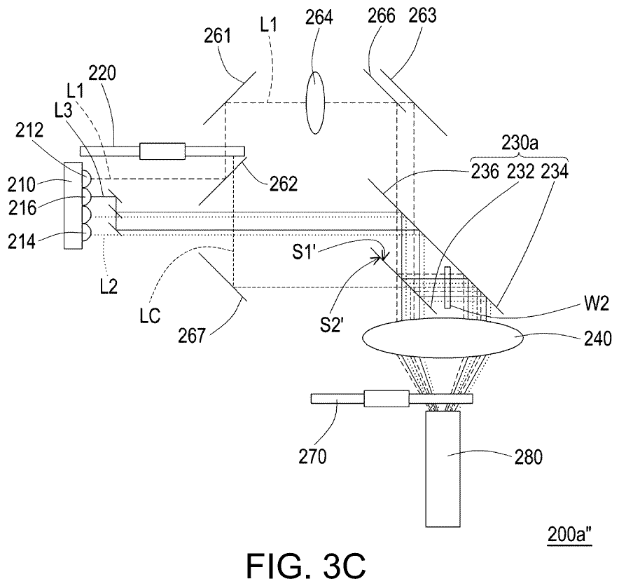

FIG. 3A is a schematic diagram of a light path of an illumination system according to another embodiment of the disclosure. Please refer to FIG. 3A. An illumination system 200a of the embodiment is similar to the illumination system 200 of FIG. 1, and main differences between the two are described as follows. In the illumination system 200a of the embodiment, a light guide module 230a further includes a light splitting element 236 that is connected with a reflection element 234 to form a single optical element. In an embodiment, the light splitting element 236 and the reflection element 234 are integrally formed. The light splitting element 236 is disposed on transmission paths of a second laser light beam L2 and a third laser light beam L3 from a light source module 210 and a first laser light beam L1 from a wavelength conversion element. The light splitting element 236 is configured to reflect the second laser light beam L2 and the third laser light beam L3 to a first full-spectrum light splitting element 232, and the light splitting element 236 is configured to allow the first laser light beam L1 from a wavelength conversion element 220 to pass through and be transmitted to the first full-spectrum light splitting element 232. In an embodiment, the light splitting element 236 is, for example, a dichroic mirror.

In the embodiment, the first laser light beam L1, the second laser light beam L2, and the third laser light beam L3 are all incident on a first side S1′ of the first full-spectrum light splitting element 232, and a conversion light beam LC is incident on a second side S2′ of the first full-spectrum light splitting element 232. In this embodiment, the first side S1′ faces the light splitting element 236, and the second side S2′ faces the light source module 210.

In the embodiment, the first laser light beam L1 from the first laser light source 212 is reflected by a dichroic mirror 262 to the wavelength conversion element 220. During a first timing T1, a second timing T2, and a fourth timing T4, the wavelength conversion element 220 converts the first laser light beam L1 into the conversion light beam LC. After the conversion light beam LC passes through the dichroic mirror 262, the conversion light beam LC is reflected by a reflector (reflected mirror) 267 to the second side S2′ of the first full-spectrum light splitting element 232. On the other hand, during a third timing T3, the first laser light beam L1 passes through a third region R3 of the wavelength conversion element 220, and then is reflected by a reflector (reflected mirror) 261 to a beam splitter 266. The beam splitter 266 reflects part of the first laser light beam L1 to the light splitting element 236, and allows another part of the first laser light beam L1 to pass through and be transmitted to a reflector (reflected mirror) 263. After the another part of the first laser light beam L1 is reflected by the reflector 263, the first laser light beam L1 is transmitted to the light splitting element 236. In the embodiment, a lens 264 may be disposed on a light path between the reflector 261 and the beam splitter 266.

In an embodiment, as shown in FIG. 3B, an illumination system 200a′ further includes a half-wave plate W1 that is disposed on the transmission path of the second laser light beam L2 from the second laser light source 214 and may be configured to adjust a polarizing direction of the second laser light beam L2, for example, rotating the polarizing direction of the second laser light beam L2 by 90 degrees to be consistent with polarizing directions of the first laser light beam L1 and the third laser light beam L3. In another embodiment, as shown in FIG. 3C, an illumination system 200a″ includes a half-wave plate W2 that may be disposed on transmission paths of all light beams from the first full-spectrum light splitting element 232 (including part of the first laser light beam L1, part of the second laser light beam L2, and part of the third laser light beam L3), so that the polarizing directions of the first laser light beam L1, the second laser light beam L2, and the third laser light beam L3 are respectively rotated by 90 degrees. For example, the beams passing through the half-wave plate W2 are orthogonal in polarization to those not passing through the half-wave plate W2 with respect to their original polarization directions. In this way, the first laser light beam L1, the second laser light beam L2, and the third laser light beam L3 that illuminate on the light converging element 240 as a whole (including a first area A1 and a second area A2) may include two orthogonal polarization directions to achieve polarization balance and uniformity.

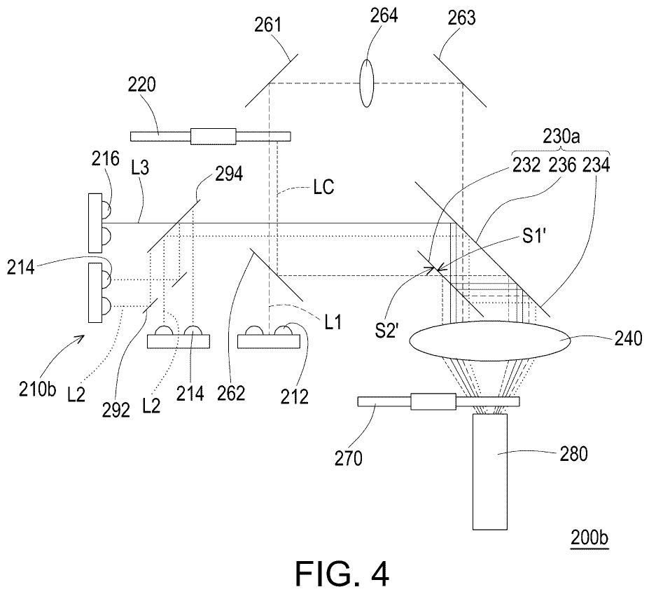

FIG. 4 is a schematic diagram of a light path of an illumination system according to another embodiment of the disclosure. Please refer to FIG. 4. An illumination system 200b of the embodiment is similar to the illumination system 200a of FIG. 3A, and main differences between the two are described as follows. In the illumination system 200b of the embodiment, a first laser light source 212, a second laser light source 214, and a third laser light source 216 are respectively located in different package modules. A light source module 210b of the embodiment includes multiple package modules, for example, a blue laser package module, two red laser package modules, and a green laser package module. In the embodiment, a dichroic mirror 262 of the illumination system 200b is located between the first laser light source 212 and a wavelength conversion element 220. The dichroic mirror 262 is configured to guide a first laser light beam L1 from the first laser light source 212 to the wavelength conversion element 220, and is configured to guide a conversion light beam LC from the wavelength conversion element 220 to a second side S2′ of a first full-spectrum light splitting element 232.

In the embodiment, a light source module 210b includes the multiple second laser light sources 214 located in different package modules. The illumination system 200b further includes a stripe light splitting element (striped beam splitter) 292 that is configured to guide the multiple second laser light beams L2 from the multiple second laser light sources 214 to the first full-spectrum light splitting element 232. In the embodiment, the stripe light splitting element 292 includes light-transmitting regions or air layers (air gaps) configured to allow a second laser light beam L2 emitted from the second excitation light source 214 of one of the package modules to pass through and be transmitted to a dichroic mirror 294. The stripe light splitting element 292 further includes reflective regions configured to reflect a second laser light beam L2 emitted from the second excitation light source 214 of another package module to the dichroic mirror 294. The dichroic mirror 294 reflects the second laser light beam L2 from the stripe light splitting element 292 to the light splitting element 236, and the dichroic mirror 294 allows a third laser light beam L3 emitted from the third laser light source 216 to pass through and be transmitted to the light splitting element 236. In the embodiment, the dichroic mirror 294 is a dichroic mirror that reflects red light.

On the other hand, the first laser light beam L1 that passes through the wavelength conversion element 220 is sequentially reflected by the reflector 261 and the reflector 263 and is transmitted to the light splitting element 236.

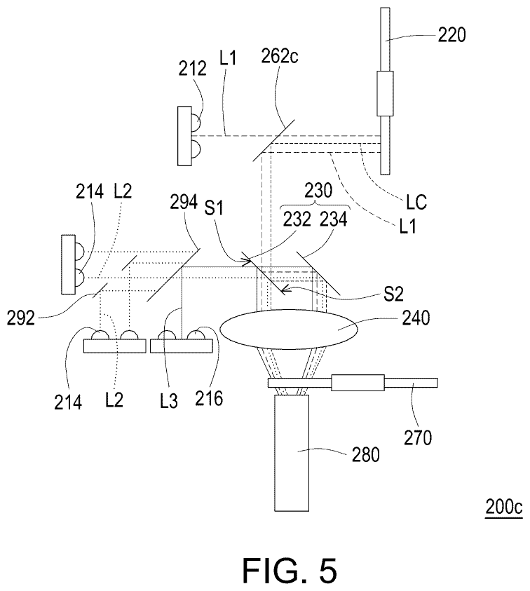

FIG. 5 is a schematic diagram of a light path of an illumination system according to another embodiment of the disclosure. Please refer to FIG. 5. An illumination system 200c of the embodiment is similar to the illumination system 200 of FIG. 1, and main differences between the two are described as follows. In the illumination system 200c of the embodiment, a first laser light source 212, a second laser light source 214, and a third laser light source 216 are respectively located in different package modules. In the embodiment, the illumination system 200c further includes a wavelength light splitting element 262c that is located between the first laser light source 212 and the wavelength conversion element 220. The wavelength light splitting element 262c is configured to guide the first laser light beam L1 from the first laser light source 212 to the wavelength conversion element 220 (for example, to allow the first laser light beam L1 to pass through and be transmitted to the wavelength conversion element 220), and is configured to guide the first laser light beam L1 and the conversion light beam LC from the wavelength conversion element 220 to the first full-spectrum light splitting element 232 (for example, to reflect the first laser light beam L1 and the conversion light beam LC to the second side S2 of the first full-spectrum light splitting element 232).

In the embodiment, a third region R3 of the wavelength conversion element 220 is a reflection region. During a third timing T3, the third region R3 may reflect the first laser light beam L1 back to the wavelength light splitting element 262c. In the embodiment, the wavelength splitting element 262c is a dichroic mirror (blue light partially-transmissive dichroic mirror) that reflects red light, green light, and yellow light, but allows blue light to pass through and reflect at the same time. That is to say, blue light partially passes through the wavelength splitting element 262c and is partially reflected by the wavelength splitting element 262c.

On the other hand, the stripe light splitting element 292 is configured to transmit the second laser light beam L2 emitted from the second laser light sources 214 respectively located in two package modules to a dichroic mirror 294. The dichroic mirror 294 is configured to allow the second laser light beam L2 from the stripe light splitting element 292 to pass through and be transmitted to the first side S1 of the first full-spectrum light splitting element 232, and the dichroic mirror 294 is configured to reflect the third laser light beam L3 emitted from the third laser light source 216 to the first side S1 of the first full-spectrum light splitting element 232.

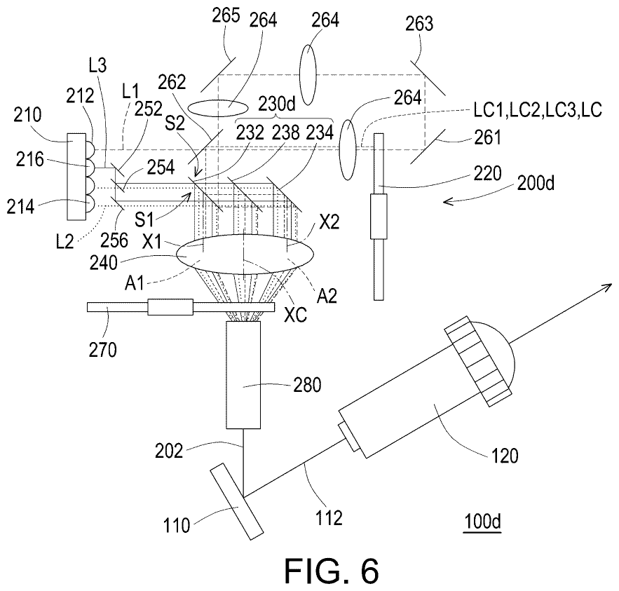

FIG. 6 is a schematic diagram of a light path of a projection apparatus according to another embodiment of the disclosure. Please refer to FIG. 6. A projection apparatus 100d of the embodiment is similar to the projection apparatus 100 of FIG. 1, and differences between the two are described as follows. In an illumination system 200d of the projection apparatus 100d of the embodiment, a light guide module 230d further includes a second full-spectrum light splitting element 238 that is disposed between the first full-spectrum light splitting element 232 and the reflection element 234. A transmittance of the first full-spectrum light splitting element 232 falls within a range of 60% to 70%, and a reflectivity thereof falls within a range of 30% to 40%; a transmittance of the second full-spectrum light splitting element 238 falls within a range of 40% to 60%, and a reflectivity thereof falls within a range of 40% to 60%. In the embodiment, the second full-spectrum light splitting element 238 is located on a central axis XC of the light converging element 240. The first full-spectrum light splitting element 232 is adapted to divide an illumination light beam 202 into a first part and a second part, and the second full-spectrum light splitting element 238 is adapted to further divide the second part of the illumination light beam 202 into a second sub-part and a third part. The second full-spectrum light splitting element 238 allows part of a first laser light beam L1, a second laser light beam L2, a third laser light beam L3, and a conversion light beam LC (the third part of the illumination light beam 202) to pass through and be transmitted to a reflection element 234, and reflects part of the first laser light beam L1, the second laser light beam L2, the third laser light beam L3, and the conversion light beam LC (the second sub-part of the illumination light beam 202) to a light converging element 240.

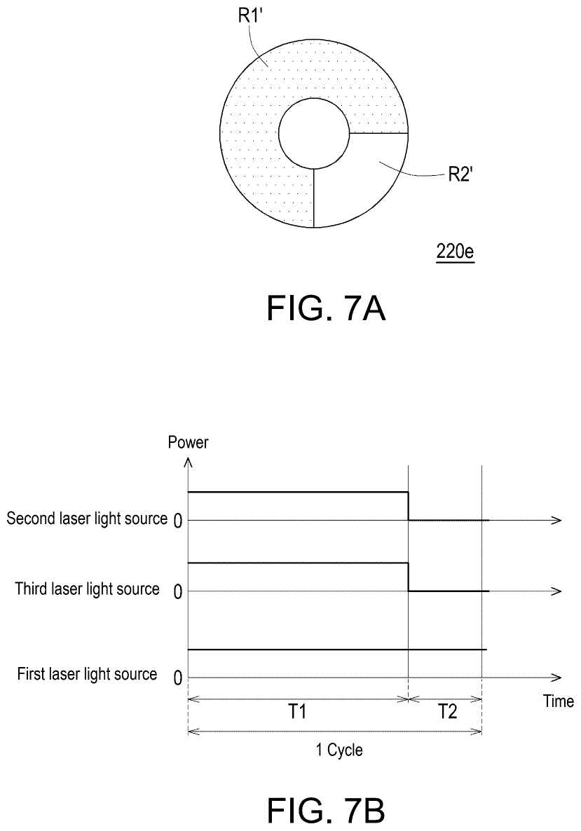

FIG. 7A is a front schematic diagram of another embodiment of the wavelength conversion element in FIG. 1, and FIG. 7B is a timing diagram of the first laser light source, the second laser light source and the third laser light source in FIG. 1, and the first region and the second region of the wavelength conversion element of FIG. 7A. Please refer to FIG. 1, FIG. 7A, and FIG. 7B. The wavelength conversion element 220 of FIG. 1 may also be substituted by a wavelength conversion element 220e of FIG. 7A. The wavelength conversion element 220e includes a wavelength conversion region R1′ and a non-wavelength conversion region R2′. The wavelength conversion region R1′ is, for example, a yellow phosphor region, and the non-wavelength conversion region R2′ is, for example, a pass-through region. In other embodiments, the non-wavelength conversion region R2′ may also be a reflection region.

In the embodiment, one cycle includes a first timing T1 and a second timing T2. During the first timing T1, the first laser light source 212, the second laser light source 214, and the third laser light source 216 are turned on, and the first laser light beam 212 is converted into a conversion light beam LC by the wavelength conversion region R1′. In the embodiment, the conversion light beam LC is, for example, a yellow light beam that may be filtered into red light by a red filtering region of the filter element 270, and may be filtered into green light by a green filtering region of the filter element 270. During the second timing T2, the first laser light source 212 is turned on, the second laser light source 214 and the third laser light source 216 are turned off, and the first laser light beam L1 passes through the non-wavelength conversion region R2′ or is reflected by the non-wavelength conversion region R2′.

In summary, the illumination system and the projection apparatus according to the embodiment of the disclosure have at least one of the following advantages: in the illumination system and the projection apparatus according to the embodiment of the disclosure, the first full-spectrum light splitting element and the reflection element are used. The first full-spectrum light splitting element is configured to guide the first part of the illumination light beam to the first area of the light converging element, and is configured to guide the second part of the illumination light beam to the reflection element. The reflection element is configured to reflect the second part of the illumination light beam to the second area of the light converging element. In this way, when the laser light beam and the conversion light beam are transmitted to the light converging element, sacrificing part of the light spectrum due to the use of a dichroic mirror disposed on the light path of the first part and the second part of the illumination light beam may be avoided. Therefore, the illumination system and the projection apparatus of the embodiment of the disclosure may effectively improve the light utilization efficiency to allow the projection apparatus to provide a projection image with higher brightness. That is to say, in the illumination system and the projection apparatus of the embodiment of the disclosure, the laser light beam and the conversion light beam that have overlapping wavelength ranges may perform light combining during the same timing, so the light combining efficiency is high. In the illumination system and the projection apparatus of the embodiment, the speckle phenomenon may be decreased by the light source module being in conjunction with the wavelength conversion element, and using the first full-spectrum light splitting element and the reflection element to merge light paths may effectively shrink the size of the illumination system and the projection apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, configured to provide an illumination light beam, wherein the illumination system comprises a light source module, a wavelength conversion element, a light guide module, and a light converging element, wherein:
the light source module comprises a first laser light source, a second laser light source, and a third laser light source, respectively configured to emit a first laser light beam, a second laser light beam, and a third laser light beam of different wavelengths;
the wavelength conversion element is disposed on a transmission path of the first laser light beam, and configured to convert the first laser light beam into a conversion light beam in sequence; and
the light guide module comprises a first full-spectrum light splitting element and a reflection element, wherein:
the first full-spectrum light splitting element is disposed on transmission paths of the second laser light beam and the third laser light beam from the light source module and the first laser light beam and the conversion light beam from the wavelength conversion element, the second laser light beam and the third laser light beam are incident on a first side of the first full-spectrum light splitting element, the conversion light beam is incident on a second side of the first full-spectrum light splitting element, the first full-spectrum light splitting element is configured to guide a first part of the illumination light beam to a first area of the light converging element, and is configured to guide a second part of the illumination light beam to the reflection element;
the reflection element is configured to reflect the second part of the illumination light beam to a second area of the light converging element; and
the illumination light beam comprises at least one of the first laser light beam, the second laser light beam, the third laser light beam, and the conversion light beam.

2. The illumination system according to claim 1, wherein a transmittance of the first full-spectrum light splitting element falls within a range of 40% to 60%, and a reflectivity thereof falls within a range of 40%-60%.

3. The illumination system according to claim 1, wherein the light guide module further comprises a second full-spectrum light splitting element disposed between the first full-spectrum light splitting element and the reflection element, wherein:
a transmittance of the first full-spectrum light splitting element falls within a range of 60% to 70%, and a reflectivity thereof falls within a range of 30%-40%; and
a transmittance of the second full-spectrum light splitting element falls within a range of 40% to 60%, and a reflectivity thereof falls within a range of 40%-60%.

4. The illumination system according to claim 3, wherein the second full-spectrum light splitting element is located on a central axis of the light converging element.

5. The illumination system according to claim 1, wherein the conversion light beam comprises at least one of a first conversion light beam, a second conversion light beam, and a third conversion light beam, wherein:
during a first timing, the first laser light source and the second laser light source are turned on, and the first laser light beam is converted into the first conversion light beam by the wavelength conversion element;
during a second timing, the first laser light source and the third laser light source are turned on, and the first laser light beam is converted into the second conversion light beam by the wavelength conversion element;
during a third timing, the first laser light source is turned on, and the first laser light beam passes through the wavelength conversion element or is reflected by the wavelength conversion element; and
during a fourth timing, the first laser light source, the second laser light source, and the third laser light source are turned on, and the third laser light beam is converted into the third conversion light beam by the wavelength conversion element.

6. The illumination system according to claim 5, wherein the wavelength conversion element comprises a first region, a second region, a third region, and a fourth region, respectively located on the transmission path of the first laser light beam during the first timing, the second timing, the third timing, and the fourth timing.

7. The illumination system according to claim 1, wherein the first laser light source, the second laser light source, and the third laser light source are a single package module.

8. The illumination system according to claim 1, wherein the first laser light beam from the wavelength conversion element is incident on the second side of the first full-spectrum light splitting element.

9. The illumination system according to claim 1, wherein the light guide module further comprises a light splitting element connected to the reflection element to form a single optical element, wherein:
the light splitting element is disposed on the transmission paths of the second laser light beam and the third laser light beam from the light source module and the first laser light beam from the wavelength conversion element, the light splitting element is configured to reflect the second laser light beam and the third laser light beam to the first full-spectrum light splitting element, and the light splitting element is configured to allow the first laser light beam from the wavelength conversion element to pass through and be transmitted to the first full-spectrum light splitting element.

10. The illumination system according to claim 1, wherein the first laser light beam is incident on the first side of the first full-spectrum light splitting element.

11. The illumination system according to claim 1, wherein the first laser light source, the second laser light source, and the third laser light source are respectively located in different package modules.

12. The illumination system according to claim 11, further comprising a wavelength light splitting element located between the first laser light source and the wavelength conversion element, the wavelength light splitting element configured to guide the first laser light beam from the first laser light source to the wavelength conversion element, and configured to guide the first laser light beam and the conversion light beam from the wavelength conversion element to the first full-spectrum light splitting element.

13. The illumination system according to claim 11, wherein the light source module comprises the plurality of second laser light sources located in different package modules, the illumination system further comprises a stripe light splitting element configured to guide the plurality of second laser light beams of the plurality of second laser light sources to the first full-spectrum light splitting element.

14. The illumination system according to claim 1, further comprising a light homogenizing element disposed on a transmission path of the first laser light beam, the second laser light beam, the third laser light beam, and the conversion light beam from the light converging element.

15. The illumination system according to claim 14, further comprising a filter element located between the light converging element and the light homogenizing element.

16. The illumination system according to claim 1, further comprising a half-wave plate disposed on the transmission path of the second laser light beam from the second laser light source or the first full-spectrum light splitting element.

17. The illumination system according to claim 1, wherein the wavelength conversion element comprises a wavelength conversion region and a non-wavelength conversion region, wherein:
during a first timing, the first laser light source, the second laser light source, and the third laser light source are turned on, and the first laser light beam is converted into the conversion light beam by the wavelength conversion region; and
during a second timing, the first laser light source is turned on, and the first laser light beam passes through the non-wavelength conversion region or is reflected by the non-wavelength conversion region.

18. The illumination system according to claim 1, wherein a main optical axis of the first part of the illumination light beam incident on the first area of the light converging element and a main optical axis of the second part of the illumination light beam incident on the second area of the light converging element are symmetrical with respect to a central axis of the light converging element.

19. A projection apparatus, comprising the illumination system according to claim 1, a light valve, and a projection lens, wherein the light valve is disposed on a transmission path of the illumination light beam and configured to convert the illumination light beam into an image light beam, and the projection lens is disposed on a transmission path of the image light beam and configured to project the image light beam out of the projection apparatus.
